(19) United States
(12) Patent Application Publication
(10) Pub. No.: US 2018/0207675 A1
(43) Pub. Date: Jul. 26, 2018

(54) SELECTIVE METERED DOSE DISPENSING DEVICE

(71) Applicant: NH Real Estate Holdings Ltd., Toronto (CA)

(72) Inventors: John-Philip Ventur, Montreal (CA); Billy Morrison, San Jose, CA (US); Andrea Bednarczyk, Montreal (CA); Marco DelBusso, Toronto (CA)

(21) Appl. No.: 15/798,381

(22) Filed: Oct. 30, 2017

Related U.S. Application Data
(60) Provisional application No. 62/414,717, filed on Oct. 29, 2016.

(51) Int. Cl. B05C 17/005; B65D 81/32

(52) U.S. Cl. CPC B05C 17/00593; B05C 17/00576; B05C 17/00516; B65D 81/325

(57) ABSTRACT

An improved dispensing device for application and dispensing of viscous liquid substances comprising of a storage reservoir, dosing mechanism with audible and tactile feedback, dispensing plunger, nozzle tip, and end of travel pressure release mechanism. The dosing and the dispensing are de-coupled, allowing a preselection of dosage volume and controlled dispensing. A pressure relief mechanism is incorporated to eliminate oozing of liquids after the termination of dispensing.

### FIELD

The present disclosure relates to the technical field of dispensing viscous liquid substances. More particularly, the present invention is in the technical field of metered dosing and dispensing of high viscosity creams, liquids, adhesives, and non-Newtonian substances.

### BACKGROUND

Portable liquid dispensing devices are widely used in the pharmaceutical, cosmetics, and industrial sectors to precisely dispense creams, topical medications, tooth paste, adhesives, food products, and more. Existing portable liquid dispensing devices rely on coupled linkages where the rotation of a threaded cylinder or actuation of a crank advances a pressure piston in conjunction with the actuation. The user controls the dispensing of the liquid via force feedback and visual control of the liquid being dispensed. When used with more viscous fluids these existing devices fail. Caulking, adhesive glue, honey, peanut butter, tooth pastes, lubricants, and plant oil extracts are examples of such viscoelastic substances with high commercial value.

Viscoelastic fluids do not flow in proportion to the pressure applied to them. These fluids are “springy” and store up pressure before flowing. Once flowing, they tend to release all the built-up pressure until the fluid is again at rest. These springy viscoelastic liquids will continue to ooze and dispense long after the user has stopped applying force to the dispensing device. The problem with current portable dispensing products is that there is usually no way for users to easily cut off this back pressure, or predictably control the end of their dispensing. This leads to wasted product, uneven volumes dispensed, spoiled product, damage to personal property such as clothing, and a mess in the home or workspace.

Positive piston displacement is used to move the fluid from the reservoir to the target location. The piston is either directly actuated as in a syringe, moved as part of a threaded assembly, or advanced via a gear and crank mechanism.

There is a need for improved solutions to dispense non-Newtonian substances which allow portability by the user, selective dosing amounts, and clean operation. Desirably, the solution would allow easy selectivity and management of these difficult fluids so that they do not leak.

### SUMMARY

In one aspect, the present disclosure relates to a multi-dose dispenser for application of viscous fluids is disclosed. The dispenser is a portable dispensing device for liquid substances comprising of a storage reservoir, dosing mechanism with audible and tactile feedback, dispensing plunger, nozzle tip, and end of travel pressure release. The dosing occurs independently of the advancement of the dispensing plunger, thereby allowing the user to preselect and control their dosing selections per the specific fluid being dispensed. Furthermore, an end of travel positive pressure release mechanism is integrated. The pressure release is arranged such that it completely settles the liquid and removes any shear stress from the substance by translating the plunger rearward a fixed distance. This occurs without intervention of the user. Dispensing occurs reliably with minimal oozing, leakage, or mess.

In another aspect, the present disclosure relates to a dispenser for dispensing a metered amount of a viscous substance, including a cylindrical reservoir for holding the substance, having an open downstream end and an open upstream end, a nozzle on the downstream end of the reservoir, a piston with a threaded stem located in the reservoir, the threaded stem extending beyond the open upstream end of the reservoir, a cylindrical dosing plunger for rotation about the threaded stem, a stop-nut located in the reservoir and through which the stem passes with the piston located on the downstream side of the stop-nut and the cylindrical plunger located on the upstream side of the stop-nut, a spring located between the stop-nut and the cylindrical plunger, such that when the plunger is depressed, downstream movement of the threaded stem and in turn the piston is induced for dispensing the substance through the nozzle with the spring contacting the piston and the plunger, and release of pressure on the plunger causes the piston to recoil a distance upstream whereby dispensing of the substance is stopped. In another aspect, in the dispenser, rotation of the plunger in one direction about the threaded stem moves the plunger in a direction away from the open upstream end with the amount of the plunger that extends beyond the open upstream end commensurate with the setting of a metered amount. In a further aspect, the dispenser can further include a bezel on the plunger whereby rotation of the bezel induces rotation of the plunger. In a still further aspect, in the dispenser, the nozzle includes a heat dispensing fin for thermally isolating of the downstream end of the nozzle from the rest of the dispenser. The dispenser can further include a second spring. The first spring can be a dosing spring and the second spring can be a pressure release spring.

### BRIEF DESCRIPTION OF THE DRAWINGS

FIG. 1 is a perspective view of a dispensing device according to an embodiment of the present invention;

FIG. 2 is a side view of the device of FIG. 1;

FIG. 3 is a cross-section view taken along line A-A of FIG. 2;

FIG. 4 is an exploded view of the device of FIG. 1;

FIG. 5 is cross-section of a dispensing device according to another embodiment of the present invention;

FIG. 6 is a perspective cross-section view of a nozzle according to another embodiment of the present invention;

FIG. 7 is a side view of a portion of the device of FIG. 5;

FIG. 8 is a longitudinal cross-section view of the device of FIG. 7;

FIG. 9 is a side view of a device of FIG. 5;

FIG. 10 is a longitudinal cross-section view of the device of FIG. 9;

FIG. 11 is a side view of a device of FIG. 5;

FIG. 12 is a longitudinal cross-section view of the device of FIG. 11;

FIG. 13 is a side view of a device of FIG. 5;

FIG. 14 is a longitudinal cross-section view of the device of FIG. 13;

FIG. 15 is a side view of a device of FIG. 5;

FIG. 16 is a longitudinal cross-section view of the device of FIG. 15;

FIG. 17 is a side view of a device, nozzle end up, according to another embodiment of the present invention;

FIG. 18 is the device of FIG. 17, nozzle end down in the carb cap functioning as a stand;

FIG. 19 is a perspective view of an upper portion of the device of FIG. 17 with the carb cap removed;

FIG. 20 is a partial section view of a lower portion of the device of FIG. 18;

FIG. 21 is partial cut away view of the carb cap of FIG. 20;

FIG. 22 is a perspective view of a dual-sided ratchet in the device of FIG. 17.

FIG. 23 is a side view of the ratchet of FIG. 22;

FIG. 24 is an end view as seen from the left of FIG. 23;

FIG. 25 is a view of a portion of the nozzle end of the device of FIG. 17 with the nozzle removed;

FIG. 26 is a cross-section view of the nozzle and piston and a portion of the device FIG. 17;

FIG. 27 is a side view of the nozzle of FIG. 26;

FIG. 28 is a top perspective view of the bezel of the device of FIG. 17;

FIG. 29 is a bottom perspective view of the bezel of FIG. 28,

FIG. 30 is a perspective view of the push button of FIG. 28;

FIGS. 30a-35 are longitudinal cross-section views of portions of the device of FIG. 17.

### DETAILED DESCRIPTION OF THE INVENTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments so described.

Referring to the Figures, in an exemplary embodiment, a dispensing piston 16 is assembled inside a cylindrical reservoir 18 and locked from rotation by a stop-nut 14. The piston 16 is only capable of motion along the longitudinal axis of the cylindrical reservoir 18. The piston 16 has a threaded rear stem 17 onto which is attached a dosing plunger 12 including longitudinally extending ridges 2. The ridges 2 of the dosing plunger 12 slide in the longitudinally extending slots 11 of a rotating bezel 10 with threaded interior channel 30 and turns on the threads 32 of the threaded rear stem 17 of the piston 16. The rotating bezel 10 is snapped into the rearward opening of the reservoir 18. The rotating bezel 10 is capable only of rotation. The rotation of the rotating bezel 10 will advance the threaded dosing plunger 12 rearward of the piston 16 without moving the piston 16. As the dosing plunger 12 moves rearward it will protrude outwards from the rotating bezel 10. Clockwise rotation of the rotating bezel 10 will further move the dosing plunger 12 rearward and act to increase the metered dose. Between the dosing plunger 12 and the stop-nut 14 is a pressure relief spring 13 which acts as both a pressure relief and ratchet mechanism for audible feedback of dosing amounts during rotation of the rotating bezel 10. The rotating bezel 10, dosing plunger 12, stop-nut 14, pressure relief spring 13, and piston 16 are rigidly connected and snap into the rearward opening 15 of the reservoir 18 to complete the assembly. A nozzle 20 is assembled on the forward opening 21 of the reservoir 18 for dispensing.

This arrangement of components allows for the separation of dosing and dispensing. In operation, a user turns the rotating bezel 10 to initiate the dose selection and listens for and feels for audible and tactile feedback provided for by the design elements of the rotating bezel 10 and the pressure relief spring 13 components. Rotation of the rotating bezel 10 in the counter clockwise, and clockwise directions may be applied by the user to reset the dose selection prior to dispensing. The audible and tactile feedback only function during dosing. Because the dosing plunger 12 is free to move in the slots 11 of the rotating bezel 10, it moves rearward or forwards along the threaded stem 17 of the piston 16. No forces are exerted on the piston 16, and therefore it doesn't move. Once the user has selected the desired dosage, they compress the dosing plunger 12 which engages with the piston 16 and they advance concurrently. As the piston 16 advances, it reduces the available volume in the reservoir 18, thereby causing the contained fluid to exit the device through the nozzle 20. The nozzle 20 may be press fit, bonded, welded, or threaded onto the reservoir 18 of the device to permit refilling of fluids.

Motion of the piston 16 continues so long as the user continues to apply pressure to the dosing plunger 12, or the mechanism reaches the end of travel at the pressure relief 13. Upon reaching the pressure relief spring 13, motion continues forward for a fixed amount until the user releases pressure. Now the dosing plunger 12 and piston 16 are moved rearwards of the reservoir 18 by the compressed amount of the pressure relief spring 13. This small motion rearward is pre-set in the device and may vary per the fluids being dispensed. The rearward motion of the piston 16 removes the internal stress from the fluid being dispensed and prevents any further “ooze” from exiting the nozzle 20.

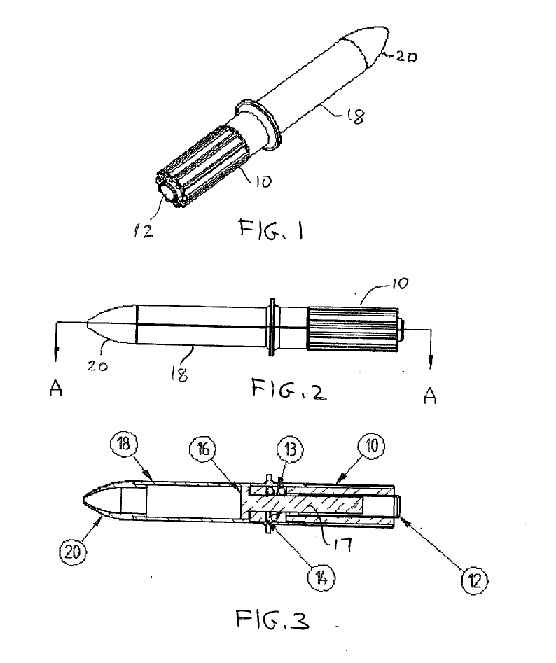

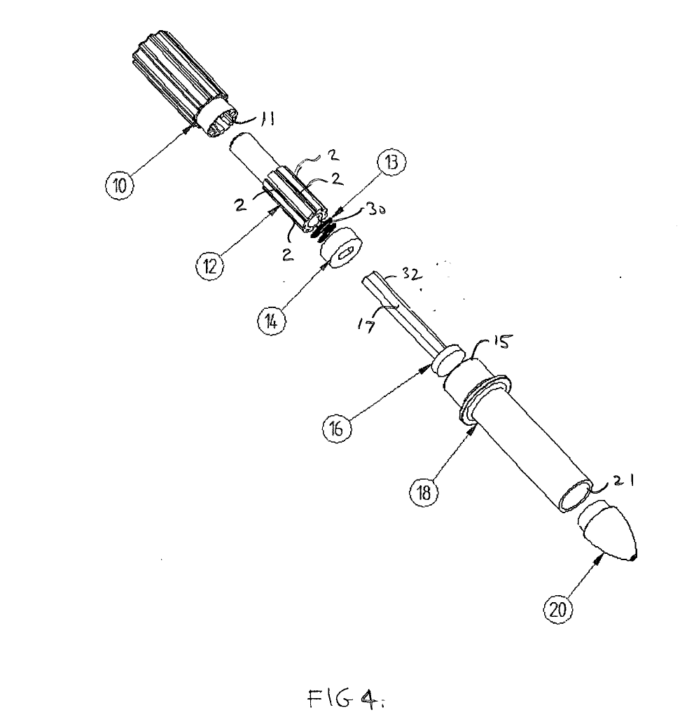

The construction details of the invention as depicted in FIGS. 1 to 4 are that the entirety of components may be made of firm plastic, either transparent or opaque or of any other sufficiently strong and rigid material that may be shaped accordingly such as high strength metal and the like. The pressure relief spring 13 may be made of metal, or from any other sufficiently rigid but flexible material such as a rubber, or plastic, and may for example be a leaf spring or a piece compressible plastic.

This kind of device is suitable for dispensing volumes of liquids in the range of 1 mL up to 1000 mL; but may be applicable to other sizes of reservoir 18. In this exemplary embodiment, a hand-held device is depicted, however one skilled in the art will appreciate that other sized embodiments are possible.

The advantages of the present invention include, without limitation, a selective dosing assembly that allows the user to tune their dispensed amount prior to applying force to the liquid in the reservoir 18. The pressure relief spring 13 action removes the final forces acting on the fluid and eliminates the oozing. By separating the dosing from dispensing we can greatly minimize material waste through oozing, or excess material use. Additionally, we see vast improvements over general leakage of substances. Users also have a greater control over the precision of their application as they don't have to focus simultaneously on applying dispensing pressure, and monitoring the amount being dispensed.

In broad embodiment, the present invention is a precision dispensing device for viscous materials and liquids that permits a wide range of pre-selectable doses.

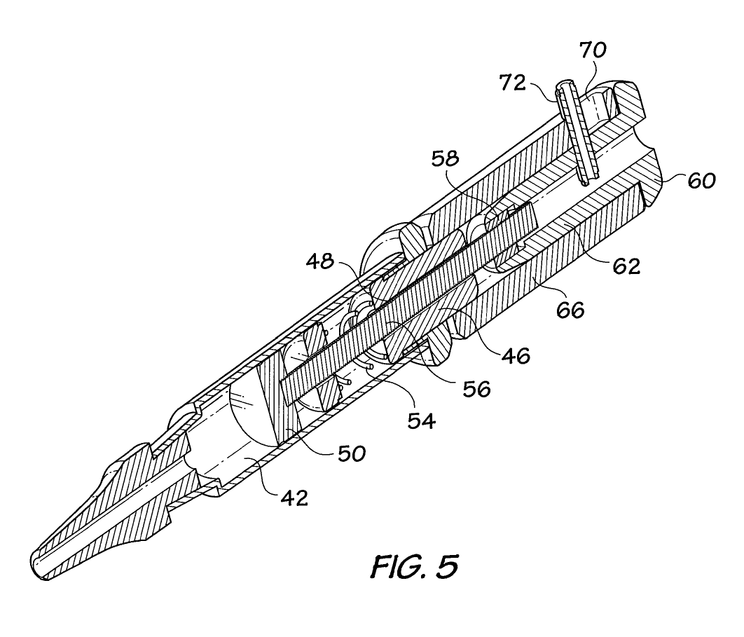

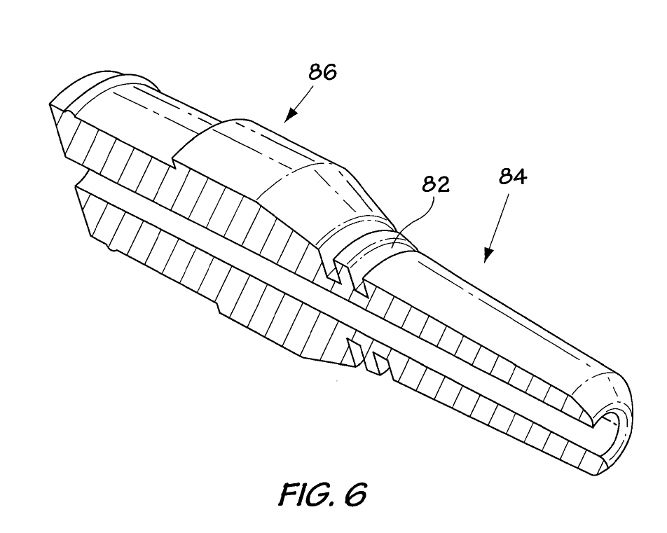

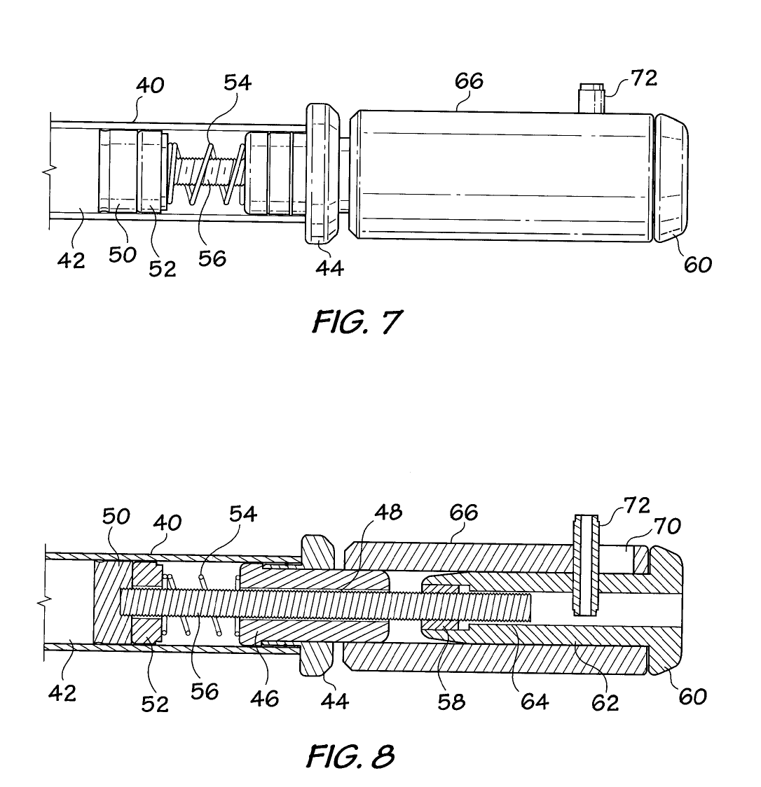

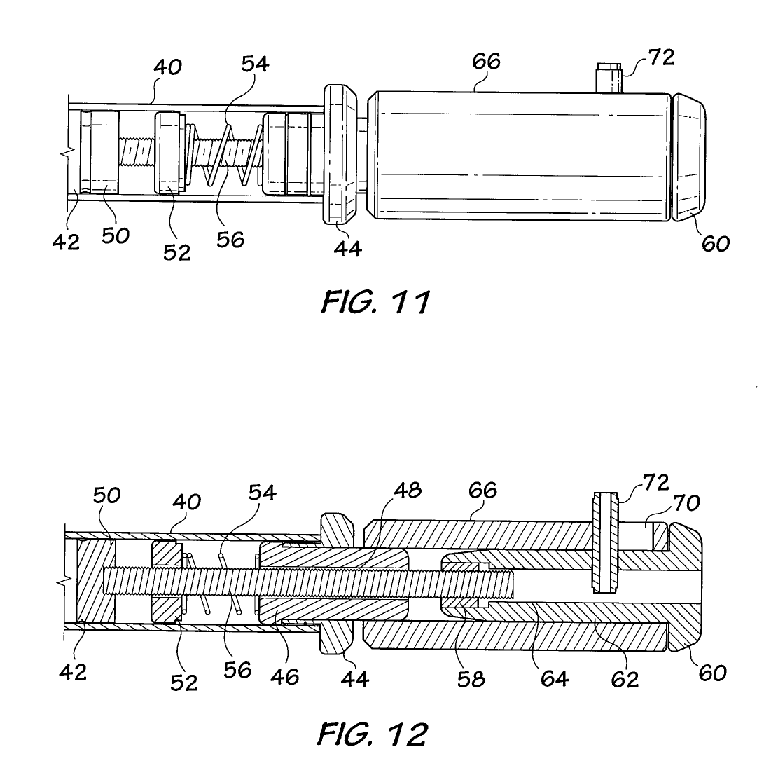

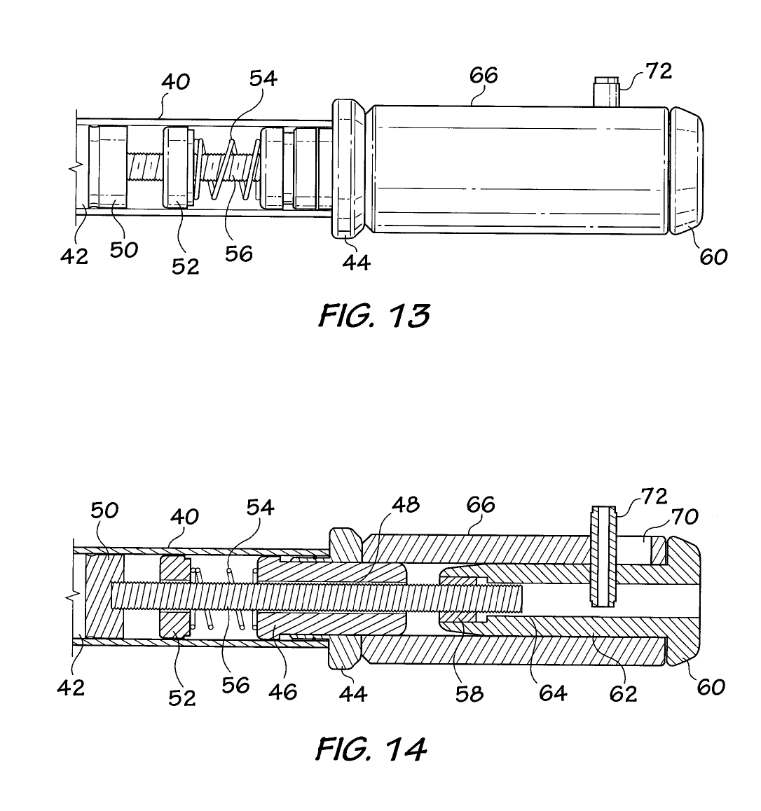

Referring to FIGS. 7 to 16, a dispenser according to another embodiment of the present invention includes a tubular housing 40. The housing 40 includes a reservoir 42 which is partially shown in FIGS. 7 to 16. In other embodiments, the reservoir can include a refillable cartridge. The downstream portion of the reservoir 42 to the left of the break lines in FIGS. 6 to 15 can be as depicted in FIGS. 1 to 14. An end cap 44 with an internal tube 46 is located in the upstream end of the housing 40. The tube 46 includes a longitudinal central channel 48. A plunger 50 and stop-nut 52 are located in the reservoir 42. A spring 54 extends between the stop-nut 52 and the downstream end of the internal cylinder 46. A threaded stem 56 extends from the plunger 50 through the stop-nut 52, central channel 48 and a threaded nut 58. A knob 60 with a cylindrical shaft 62 is attached to the threaded nut 58. The threaded stem 56 extends into longitudinal central channel 64 of the cylindrical shaft 62. A tubular housing 66 is rotatably mounted on the outer end 65 of the tube 46 and houses the cylindrical shaft 62. The cylindrical shaft 62 includes an opening 70 and an arm 72 is attached to the cylindrical shaft 62. The arm 72 extends through the opening 70.

In operation, a non-dosing resting position of the dispenser is depicted in FIGS. 6 and 7. Rotation of the knob 60 causes rotation of the threaded nut 58 around the threaded shaft and causes the threaded nut 58 to travel along the threaded stem 56 and in turn carry the cylindrical shaft 62. Rotation of the knob 60 in the counter-clockwise direction causes the knob 60 to move out from the upstream end of the tubular housing 66 and with a clockwise rotation of the knob 60 causing the knob 60 to move toward the end of the tubular housing 66. In other embodiments, the threading of the threaded stem and threaded nut can be reversed such that the counter-clockwise rotation of the knob causes the knob 60 to travel toward the upstream end of the cylindrical housing and a clockwise rotation causes the knob 60 to travel away from the upstream end of the tubular housing 66. The distance of travel of the tubular shaft is commensurate with the number of rotations of the knob 60 and defines a desired dispensing dose.

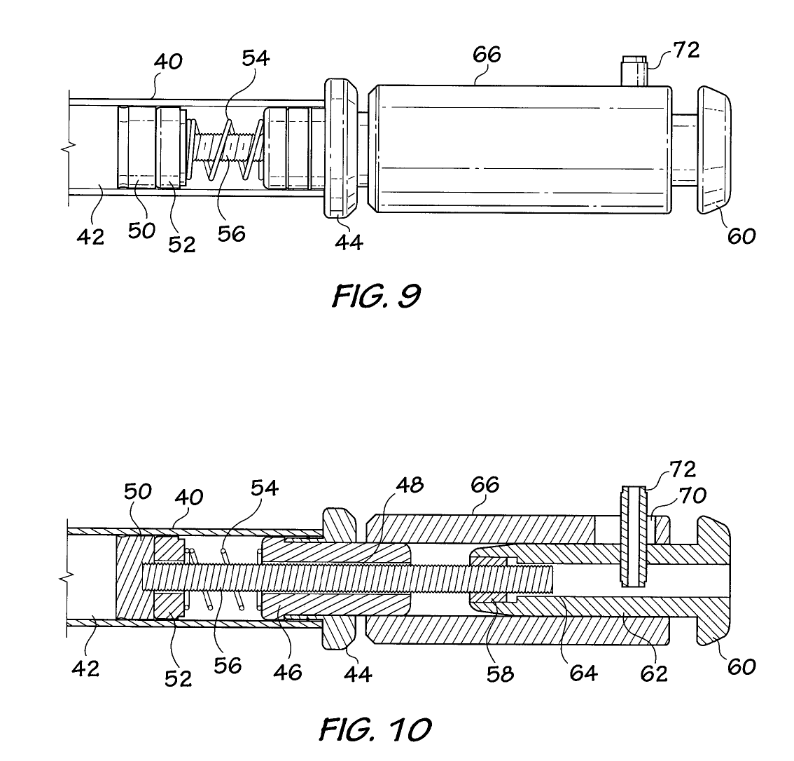

In FIGS. 9 and 10, the knob 60 is depicted in a position at a desired spacing from the upstream end of the tubular housing 66. The dispenser is now positioned for dispensing contents (not shown) from the reservoir 42. Depressing the knob 60 or alternatively, moving the arm 72 in the downstream direction, causes the cylindrical shaft 62, the tubular housing 66, the threaded nut 58, the threaded stem 56 and in turn the plunger 50 to move together in the downstream direction. The spring 54 is engaged as the threaded shaft travels downstream. The travel of the plunger 50 is stopped once the knob abuts the upstream end of the tubular housing 61. In this embodiment, the stop-nut 52 is designed to stay in position in the reservoir 42 while the plunger 50 moves.

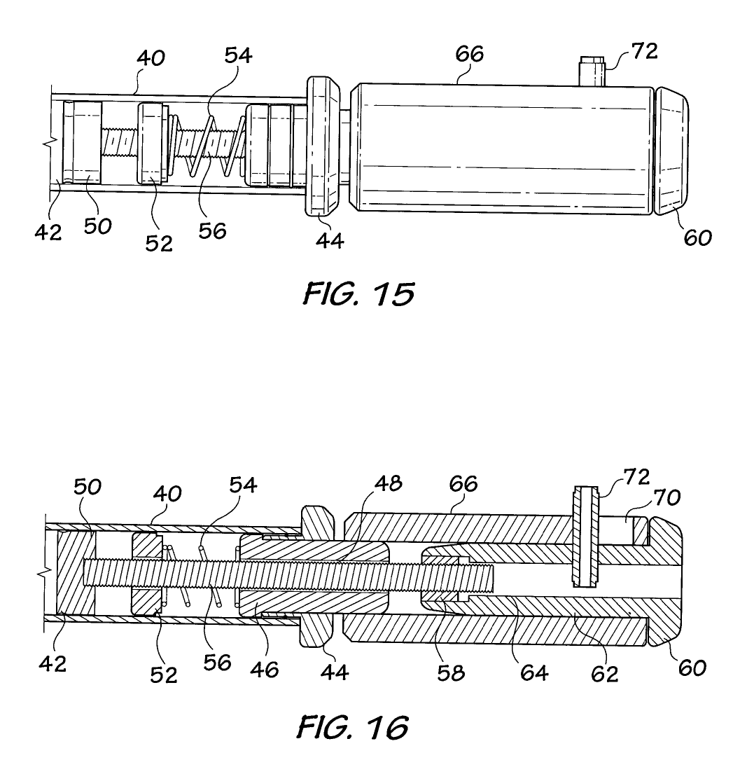

Referring to FIGS. 15 and 16, once depressing pressure is released from the knob 60 or alternatively the arm 72, the engaged spring 54 acts on the threaded stem 56 to move the threaded stem 56 and in turn the plunger 50, the cylindrical shaft 62 and the housing 66 upstream slightly to return the plunger 50 to the resting position of FIGS. 7 and 8.

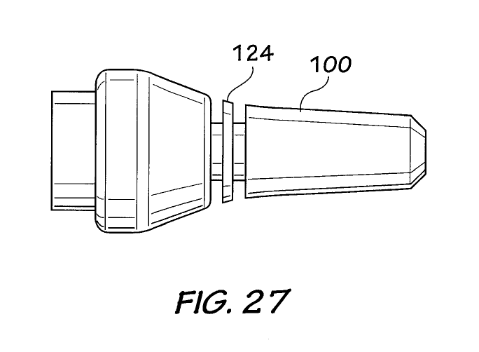

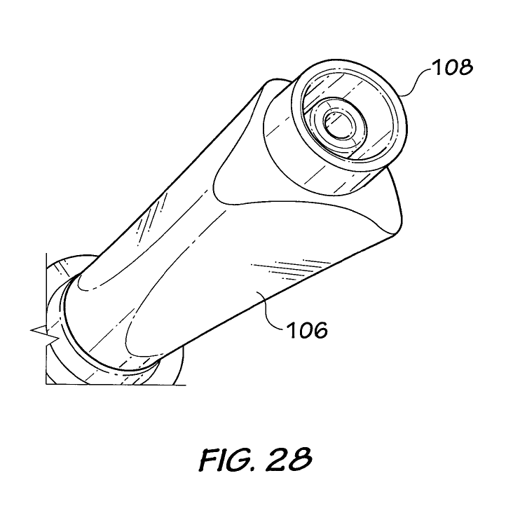

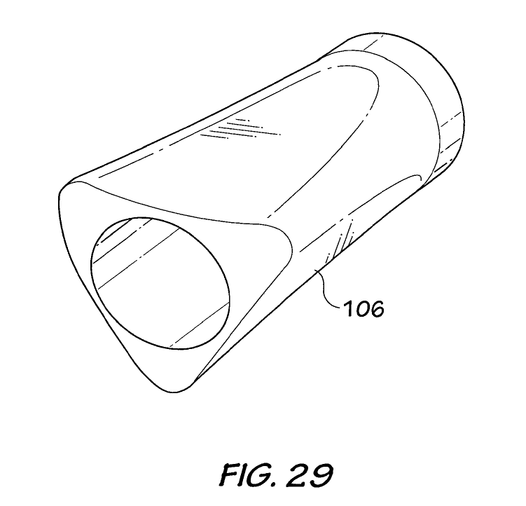

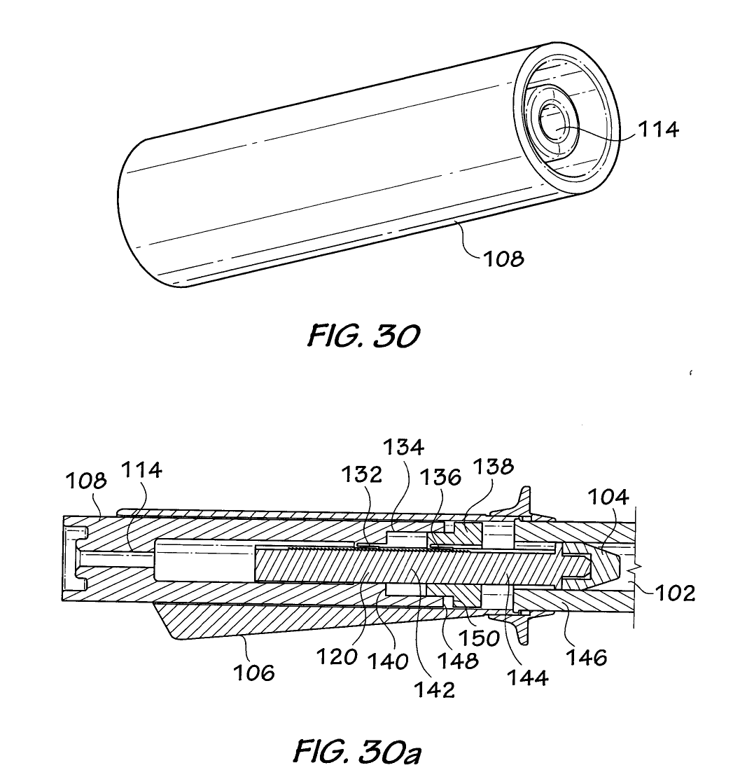

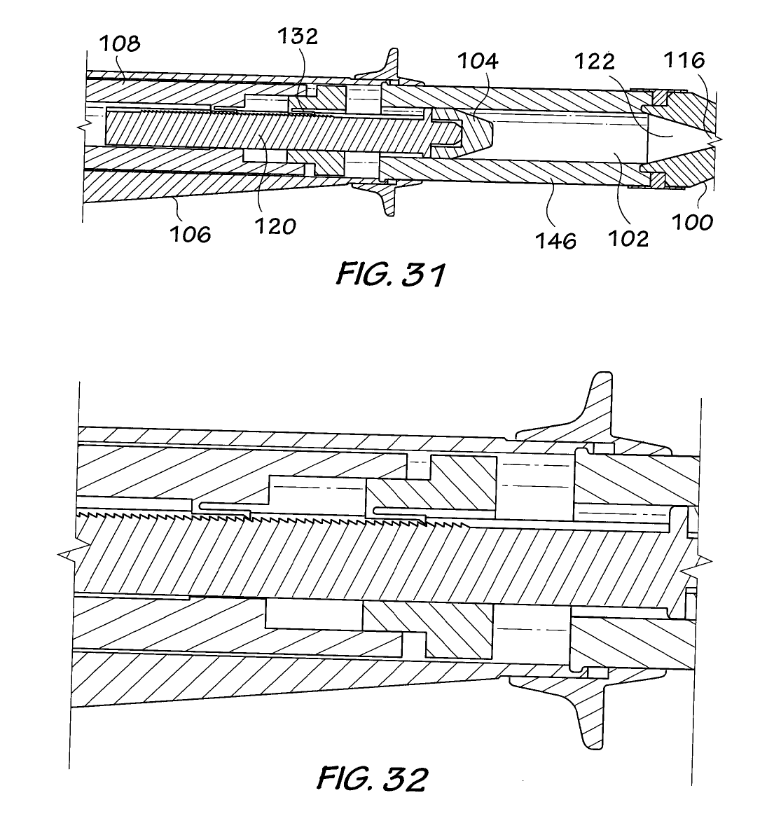

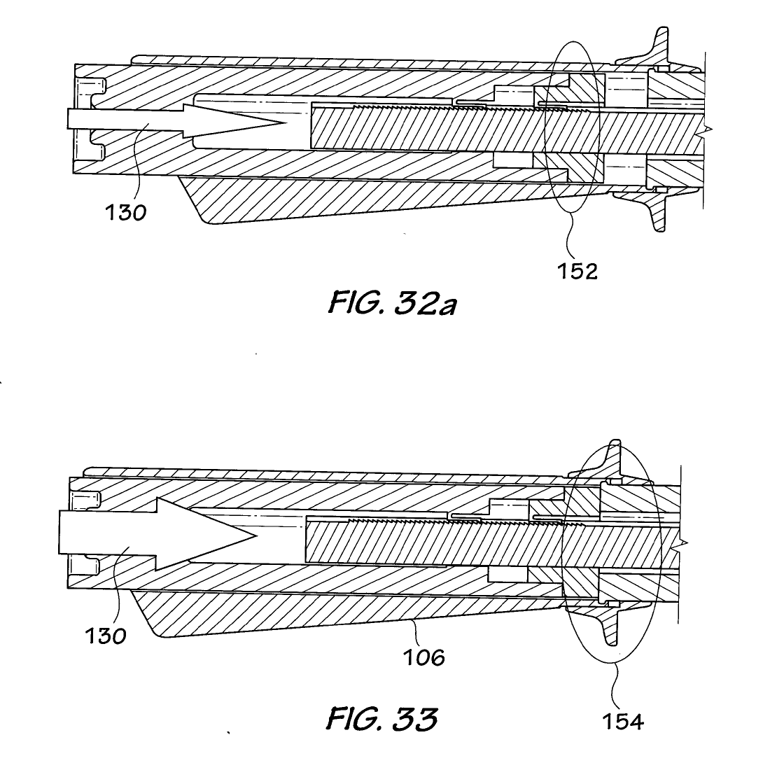

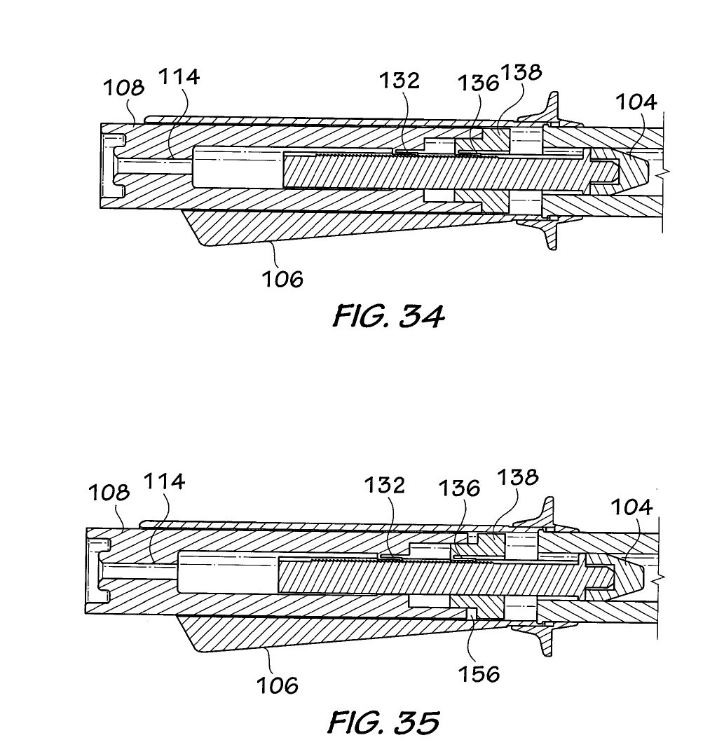

Referring to FIGS. 6 and 27, a nozzle according to another embodiment of the present invention includes a central orifice 80 radial heat dissipating fin 82 for thermally isolating the downstream end indicated generally at 84 of the nozzle from the upstream end indicated generally at 86 of the nozzle. The nozzle of FIG. 6 can be used for exampling when dabbing a substance to minimize thermal transfer from downstream end 84 to a substance in the reservoir 42.

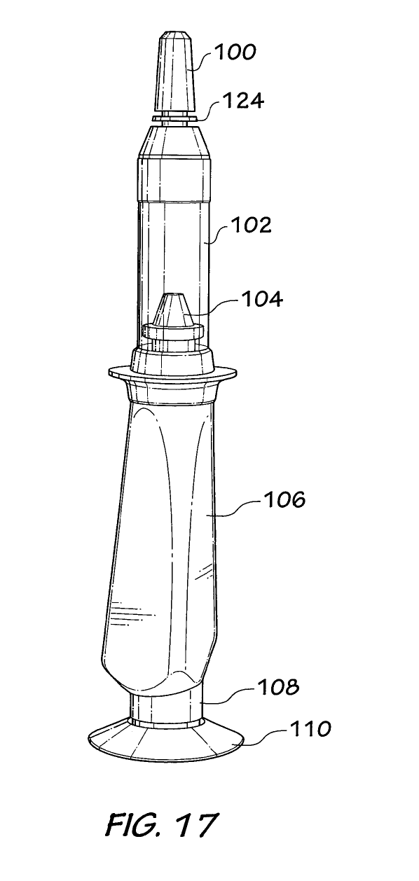

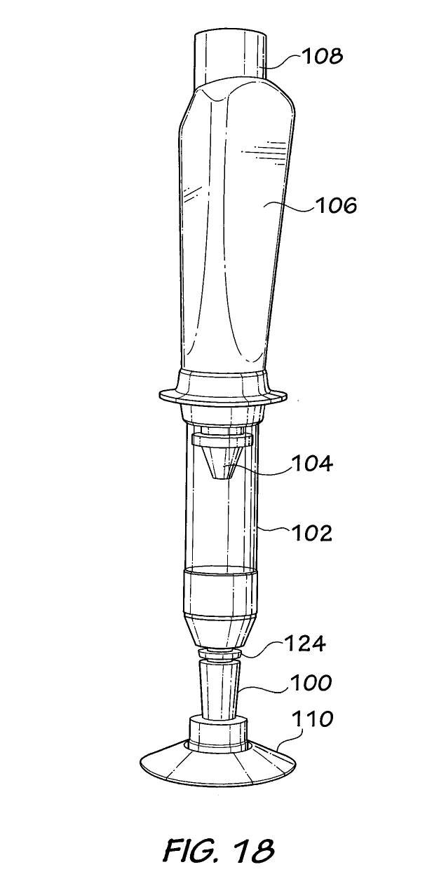

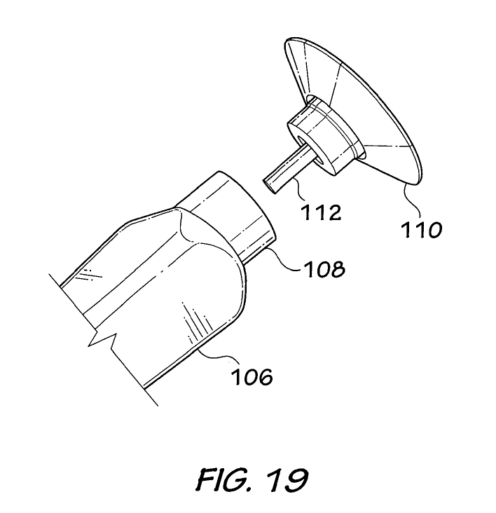

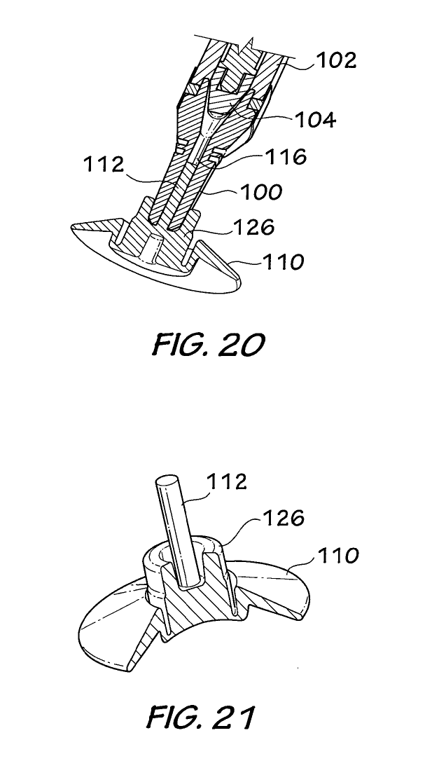

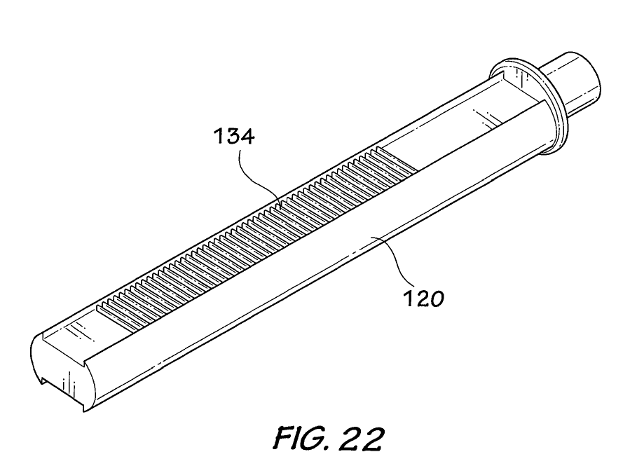

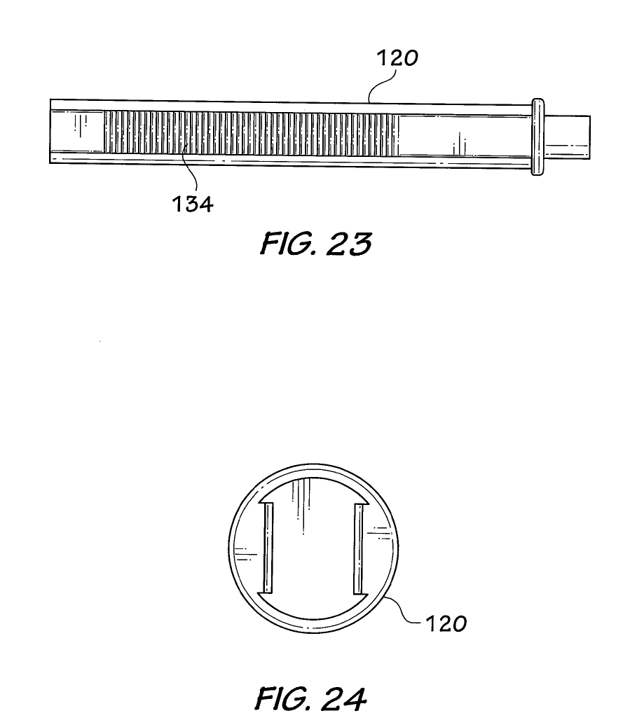

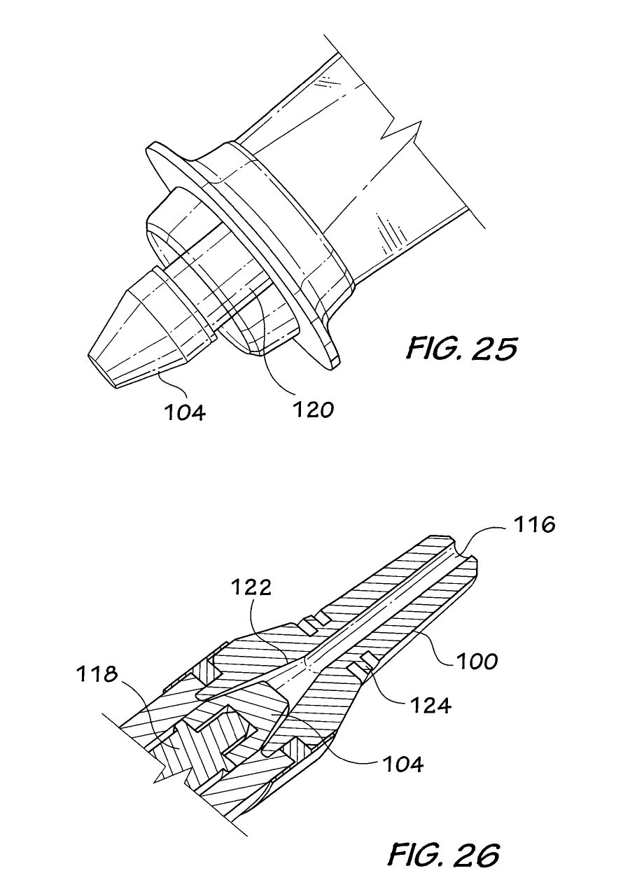

Referring initially to FIG. 17, a device according to another embodiment of the present invention relates to a dispensing device including a nozzle 100, reservoir 102, frusto-conical piston 104, a non-rotating bezel 106 (serving as a housing), push button 108 and carb-cap 110. The carb-cap includes stem 112 which is insertable in passage 114 of push button 108 when the carb-cap is fitted to the top of the bush-button 108. Referring to FIG. 19, the carb-cap 110 can be removed from the push button 108 and used as a stand for the device as depicted in FIG. 18 and FIG. 20. An annular flange 126 receives the nozzle 100. The stem 112 of the carb-cap is insertable into passage 116 of the nozzle 100 to clean or unclog the nozzle 100. The carb-cap can be made of a flexible and heat resistant material such as silicon.

In the device of FIG. 17, the stem 118 of piston 104 is indirectly driven by a ratchet 120. Pushing the push button 108 actuates the ratchet 120 to advance the piston 104 in the direction indicated by arrow 130 (“downstream”). When push button 108 is pressed, pawl 132 on the push button 108 engages teeth 134 on ratchet 120 to advance ratchet 120 (which serves as the piston stem for piston 104) past the pawl 136 on carriage 138 to advance the piston 104 by a set amount. The pawl 136 only permits the ratchet to advance in the direction of the arrow 130. The amount of travel of the piston 104 is governed by the pitch of the teeth 134. As the bush button 108 advances, rim 140 compresses a spring 142 (also referred to herein as the “dosing spring”) located between the push button 108 and the carriage 138, while the carriage 138 compresses spring 144 (also referred to herein as the “pressure release spring”) located between the carriage 138 and the walls 146 of the reservoir 102. With pushing force on the push button 108 can be advanced until the leading edge 148 of the push button 108 contacts the detent 150 of the carriage 138 (as seen in the area of oval 152. The oval 152 does not form part of the present invention). With further pushing force on the push button 108, the bush button 108 and the carriage 152 can be advance together until the carriage 138 contacts the tube 146 (as seen in the area of oval 154. The oval 154 does not form part of the present invention), at which point the maximum downstream travel (and dispensing) of the piston 104 is reached (its terminal point). Upon release of pressing pressure on the push button 108, pressure on the springs 142 and 144 is released allowing them to decompress. As spring 144 is decompressed, it pushes carriage 138 and in turn the piston 104 and the push button 108 in a direction opposite the direction of the arrow 130 (upstream) thus reducing dispensing pressure on the substance being dispensed to reduce oozing of the substance. Then, spring 142 expands to push the push button 108 in the upstream direction whereby a gap 156 is once again opened between the bush button 108 and the carriage 138. In certain embodiments, the spring 142 is weaker than the spring 144.

When the piston 104 advances to a terminal point, it nests in a funnel-shaped 122 opening of the channel 116. This helps to minimize the amount of a substance being dispensed that is left in the reservoir 102. If the nozzle is made of a material such as plastic that is easily cut, it can be cut and residual amounts of the substance removed from the channel 116. The nozzle 100 includes a heat dissipating fin 124 for thermally isolating the downstream end of the nozzle from the substance in the reservoir 102.

Dispensers according to embodiments of the present invention may be used for dabbing to dispense a dab of a viscoelastic substance such as a plant oil extract, including for example substances made from plant materials such as oils made by extracting THC and other cannabinoids from plant material.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A dispenser for dispensing a metered amount of a viscous substance, comprising:
a cylindrical reservoir for holding the substance, having an open downstream end and an open upstream end;
a nozzle on the downstream end of the reservoir;
a piston with a threaded stem located in the reservoir, the threaded stem extending beyond the open upstream end of the reservoir;
a cylindrical dosing plunger for rotation about the threaded stem
a stop-nut located in the reservoir and through which the stem passes with the piston located on the downstream side of the stop-nut and the cylindrical plunger located on the upstream side of the stop-nut;
a spring located between the stop-nut and the cylindrical plunger,
such that when the plunger is depressed, downstream movement of the threaded stem and in turn the piston is induced for dispensing the substance through the nozzle with the spring contacting the piston and the plunger, and release of pressure on the plunger causes the piston to recoil a distance upstream whereby dispensing of the substance is stopped.

2. The dispenser of claim 1, wherein rotation of the plunger in one direction about the threaded stem moves the plunger in a direction away from the open upstream end with the amount of the plunger that extends beyond the open upstream end commensurate with the setting of a metered amount.

3. The dispenser of claim 2, further comprising a bezel on the plunger whereby rotation of the bezel induces rotation of the plunger.

4. The dispenser of claim 1, wherein the nozzle includes a heat dispensing fin for thermally isolating of the downstream end of the nozzle from the rest of the dispenser.

5. The dispenser of claim 1, wherein the piston is frusto-conical.

6. The dispenser of claim 1, further including a carb-cap removably mountable on the plunger.

7. A dispenser for dispensing a metered amount of a viscous substance, comprising:
a cylindrical reservoir for holding the substance, having an open downstream end and an open upstream end;
a frusto-conical piston on the downstream end of the reservoir;
a piston with a stem located in the reservoir,
a ratchet for advancing the stem in the reservoir,
a spring,
such that when the plunger is depressed, downstream movement of the stem and in turn the piston is induced for dispensing the substance from the device and release of pressure on the plunger causes the piston to recoil a distance upstream whereby dispensing of the substance is stopped.

8. The device of claim 7, further including a nozzle on the downstream end of the reservoir.

9. The dispenser of claim 8, wherein the nozzle includes a heat dispensing fin for thermally isolating of the downstream end of the nozzle from the rest of the dispenser.

10. The dispenser of claim 7, further including a second spring.

11. The dispenser of claim 10, wherein the first spring is a dosing spring and the second spring is a pressure release spring.
